(19) United States
(12) Patent Application Publication
(10) Pub. No.: US 2014/0048657 A1
(43) Pub. Date: Feb. 20, 2014

(54) CROSS FLOW FAN FLYING DEVICE

(71) Applicant: Yan-Liang Lin, Taichung City (TW)

(72) Inventor: Yan-Liang Lin, Taichung City (TW)

(21) Appl. No.: 13/692,649

(22) Filed: Dec. 3, 2012

(30) Foreign Application Priority Data
Aug. 14, 2012 (CN) 201210288602.2

(51) Int. Cl. B64C 15/00

(52) U.S. Cl. CPC B64C 15/00
USPC 244/23 A

(57) ABSTRACT

A cross flow fan flying device includes a first thrusting means having a first cross flow fan and a second thrusting means having a second cross flow fan, wherein the first flow fan and the second cross flow fan rotate in directions opposite with each other, and the cross flow fan flying device is driven and flies by airflow thrust generated by the first cross flow fan and the second cross flow fan.

### FIELD OF THE INVENTION

The present invention relates to a flying device, and more particularly to a cross flow fan flying device.

### BACKGROUND OF THE INVENTION

Flying is a dream of most people, and many flying devices have been made to chase the dream. There are various kinds of flying devices, such as a hot air balloon, an airplane, a helicopter, and the like, each of which has its individual working principle.

The hot air balloon flies by means of a gasbag fulfilled with heated air based on the principle that buoyancy is generated due to the heated air with lower density than the cold air outside the gasbag. The airplane is a motor-propelled aircraft, of which wings produce lift force based on the Bernoulli's principle. The helicopter flies by a lift force generated by one or more rotary wings with a vertical axis, and therefore has a vertical lift ability.

However, the hot air balloon has disadvantage in lower dexterity and less flying speed because it is not capable of generating a motive force. The airplane has an excellent flying speed, but it is not capable of staying at a fixed position in sky because the lift force thereof is generated by a forward motion of the wings thereof. The helicopter has a higher dexterity than the airplane, but it also has a problem of flying stability because the rotary wing thereof, which has a large projection area when rotating, is easy to be disturbanced by airflow.

### SUMMARY OF THE INVENTION

In view of the above circumstances, it is known that a conventional flying device is inadequate to fly both with dexterity and with stability. And thus the conventional flying device can not be widely used for a multiple flying purposes.

Accordingly, it is an aspect of the present invention to provide a cross flow fan flying device having excellent flying dexterity and stability for plurality flying purposes.

The present invention provides a cross flow fan flying device comprising: a first thrusting means, provided with a first cross flow fan rotating on a first axis; and a second thrusting means, connected with the first thrusting means, provided with a second cross flow fan rotating on a second axis, wherein the first flow fan and the second cross flow fan rotate in directions opposite with each other, and the cross flow fan flying device is driven and flies by an airflow thrust generated by the first cross flow fan and the second cross flow fan.

According to an embodiment of the present invention, the first axis is coaxial to the second axis.

According to an embodiment of the present invention, the first axis is parallel to the second axis.

According to an embodiment of the present invention, the first thrusting means is provided with a first guiding hood covering the first cross flow fan, and the second thrusting means is provided with a second guiding hood covering the second cross flow fan.

According to an embodiment of the present invention, the first guiding hood and the second guiding hood are angle adjustable to guide airflow directions of the first cross flow fan and the second cross flow fan respectively.

According to an embodiment of the present invention, the first thrusting means is provided with a first airflow direction adjusting member on an airflow direction of the first cross flow fan, and the second thrusting means is provided with a second airflow direction adjusting member on an airflow direction of the first cross flow fan.

According to an embodiment of the present invention, the cross flow fan flying device further comprises a tail means provided on a tail portion of the cross flow fan flying device.

According to an embodiment of the present invention, the cross flow fan flying device further comprises a propeller for propelling the cross flow fan flying device.

According to an embodiment of the present invention, the cross flow fan flying device further comprises a multiway transmitting means connected among a driving means and the first cross flow fan and the second cross flow fan for allowing the driving means to drive the first cross flow fan and the second cross flow in directions opposite with each other.

According to an embodiment of the present invention, the cross flow fan flying device further comprises a differential means connected between the first cross flow fan and the second cross flow fan.

By means of technical means of the present invention, the cross flow fan flying device is driven and flies by an airflow thrust generated by the first cross flow fan and the second cross flow fan, with advantage of having excellent flying dexterity and stability. The cross flow fan flying device is capable of flying with various motions as desired, such as moving toward direction, rotating or spinning toward any axis, or even staying at a fixed position. The cross flow fan flying device can adapt to any various flying environment, and thus to be used widely for multiple flying purposes.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view of a cross flow fan flying device of an exemplary embodiment according to the present invention;

FIG. 2 is a schematic view of a cross flow fan flying device of a first embodiment according to the present invention;

FIG. 3a is a cross-section view of the cross flow fan flying device along line 3a-3a of FIG. 2;

FIG. 3b is a cross-section view of the cross flow fan flying device along line 3b-3b of FIG. 2;

FIG. 4 is a top view of a cross flow fan flying device of a second embodiment according to the present invention;

FIG. 5a is a back view of the cross flow fan flying device of FIG. 4;

FIG. 5b is a back view of the cross flow fan flying device of FIG. 4;

FIG. 5c is a back view of the cross flow fan flying device of FIG. 4;

FIG. 6 is a back view of the cross flow fan flying device of FIG. 4;

FIG. 7a is a back view of the cross flow fan flying device of FIG. 4;

FIG. 7b is a back view of the cross flow fan flying device of FIG. 4;

FIG. 8 is a top view of a cross flow fan flying device of a third embodiment according to the present invention;

FIG. 9a is a schematic view illustrating a motion of the cross flow fan flying device of FIG. 8;

FIG. 9b is a schematic view illustrating a motion of the cross flow fan flying device of FIG. 8;

FIG. 10 is a side view of a cross flow fan flying device of a fourth embodiment according to the present invention; and

FIG. 11 is a side view of a cross flow fan flying device of a fourth embodiment according to the present invention.

### DETAILED DESCRIPTION OF THE PREFERRED EMBODIMENTS

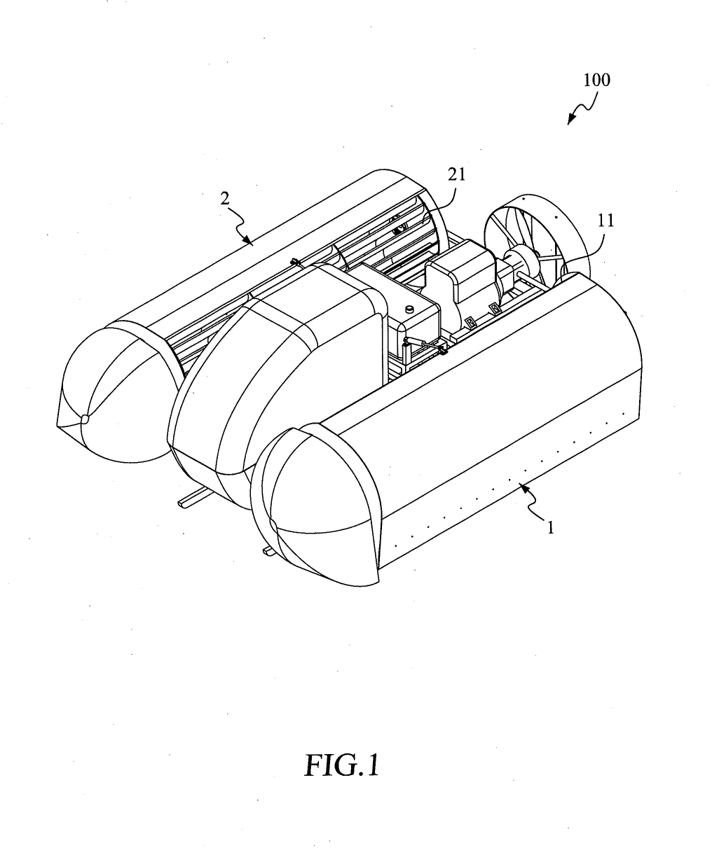

FIG. 1 shows a cross flow fan flying device 100 of an exemplary embodiment according to the present invention, in which the cross flow fan flying device 100 mainly includes a first thrusting means 1 and a second thrusting means 2 connected with the first thrusting means 1. The first thrusting means 1 and the second thrusting means 2 have a cross flow fan 11 and 12 respectively, and therefore the cross flow fan flying device can be driven and fly by an airflow thrust generated by the cross flow fans. Principle and structure of the cross flow fan flying device provided in the present invention will be described as follows in detail with reference to figures.

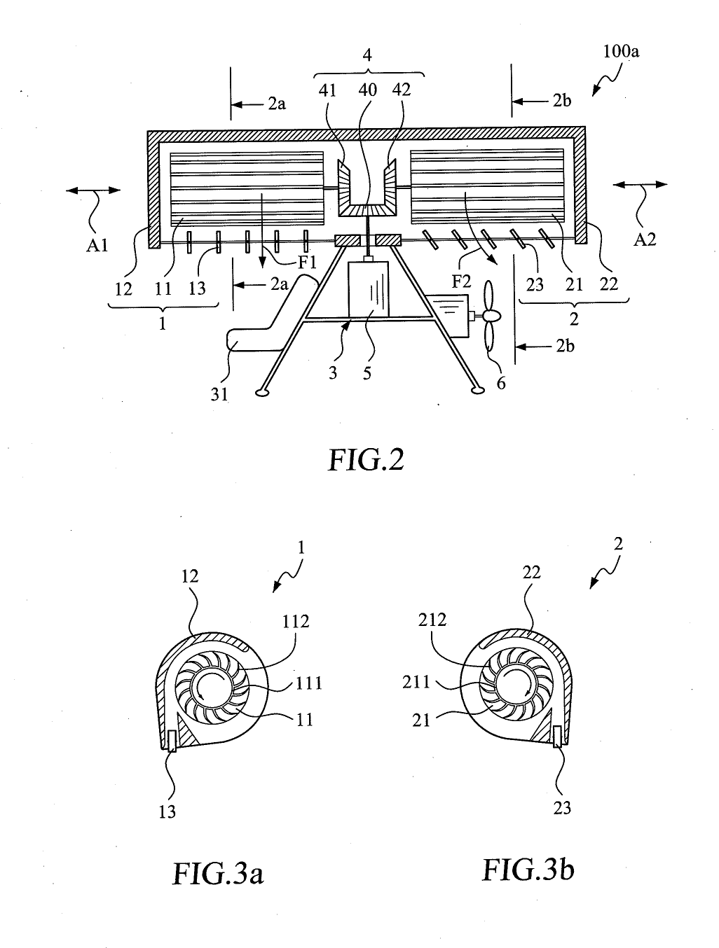

Please refer to FIGS. 2, 3a, and 3b, a cross flow fan flying device 100a according to a first embodiment of the present invention mainly includes a first thrusting means 1 and a second thrusting means 2 connected with the first thrusting means 1.

The first thrusting means 1 includes a first cross flow fan 11, a first guiding hood 12, and a plurality of first airflow direction adjusting members 13. The cross flow fan, sometimes called as a tangential fan or a tubular fan, can generate an airflow that moves transversely across the impeller of the cross flow fan while rotating. The first cross flow fan 11 includes an impeller 111, which rotates on a first axis A1 to therefore generate airflow F1 as a thrusting force by which the cross flow fan flying device 100a flies. In a preferred embodiment, the impeller 111 is further provided with a plurality of forward curved blades 112 for generating more airflow while rotating. The first guiding hood 12 covers the first cross flow fan 11 to converge and guide the airflow F1 generated by the first cross flow fan 11 to move along a planned airflow direction (e.g. a vertically downward direction or an obliquely downward direction). The first airflow direction adjusting members 13 are provided on the airflow direction of the first cross flow fan 11. For example, first airflow direction adjusting members 13 are provided on an air outlet as shown in FIG. 3. In this embodiment, the first airflow direction adjusting members 13 are angle adjustable blades. By adjusting the first airflow direction adjusting members 13 to an angle, the airflow generated by the first cross flow fan can be guided to a corresponding direction.

Similarly, the second thrusting means 2 includes a second cross flow fan 21, a second guiding hood 22, and a plurality of second airflow direction adjusting members 23. The second cross flow fan 21 also has an impeller 211 with forward curved blades 212 for increasing the airflow generated. The second cross flow fan 21 rotates on a second axis A2 to generate an airflow F1 provided as a thrusting force by which the cross flow fan flying device 100a flies. Further, the first flow fan 11 and the second cross flow fan 32 rotate in directions opposite with each other to make the cross flow fan flying device 100a stable in flying, by eliminating opposite torques to each other.

Further, in this embodiment, the first thrusting means 1 and the second thrusting means 2 are provided along a straight line and the first axis A1 is coaxial to the second axis A2. The cross flow fan flying device 100a having such a structure is smaller in width and is thus convenient for passing through a narrow space.

With such a structure described above, the cross flow fan flying device 100a can be driven and fly by the airflow thrust generated by the first cross flow fan 11 and the second cross flow fan 12. Further, the cross flow fan flying device 100a may further be provided with a body 3 for various flying purposes. For example, the body 3 may be provided with a seat 31 for carrying people.

Specifically, the cross flow fan flying device 100a of this embodiment includes a multiway transmitting means 4 connected among a driving means 5, the first cross flow fan 11 and the second cross flow fan 12. The multiway transmitting means 4 is a gear set including a driving bevel gear 40 and two driven bevel gears 41 and 42. The driving bevel gear 40 is connected with the driving means 5 and rotates by driving of the driving means 5. The driven bevel gears 41 and 42 engage on opposite sides of the driving bevel gear 40, and to form a right angle with regard to the driving bevel gear 40 respectively. In such structure, the driven bevel gears 41 and 42 are driven to rotate in opposite directions while the driving bevel gear 40 rotates. By that, the first cross flow fan 11 and the second cross flow fan 21, which rotate in directions opposite with each other, can be driven by a common driving means 5, and thus the requirement for the number of the driving means in the cross flow fan flying device can be decreased. However, the present invention is not limited to this and the first cross flow fan 11 and the second cross flow fan 21 may be driven by individual driving means in other embodiments.

In addition, the cross flow fan flying device 100a may be further includes a propeller 6 for propelling the cross flow fan flying device 100a. As shown in FIG. 2, the propeller 6 is used for generating a back airflow to increase forward speed of the cross flow fan flying device 100a. Alternatively, the propeller 6 may be provided to generating a side airflow for rotating the cross flow fan flying device 100a.

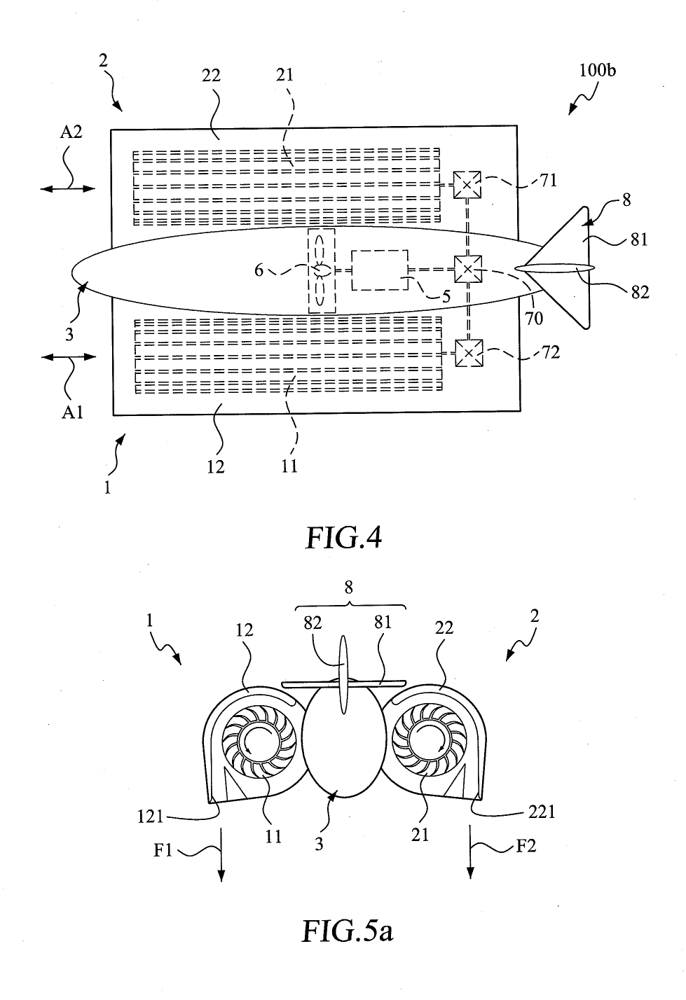

Please refer to FIGS. 4 to 7b, which are schematic drawings of various cross flow fan flying devices according to a second embodiment of the present invention. The elements of cross flow fan flying devices 100b in this embodiment are similar to those in the first embodiment. The same elements in the second embodiment are labeled with the same reference numbers as in the first embodiment. Features the same as those in the first embodiment will be omitted as appropriate.

A feature of the cross flow fan flying device 100b in the second embodiment is that the first thrusting means 1 and the second thrusting means 2 are provided side by side, and the first axis A1 is parallel to the second axis A2. The cross flow fan flying device 100b can be driven and fly by an airflow thrust generated by the first cross flow fan 11 and the second cross flow fan 12. Further, the first flow fan 11 and the second cross flow fan 32 rotate in directions opposite with each other to make the cross flow fan flying device 100b stable in flying by eliminating opposite torques to each other.

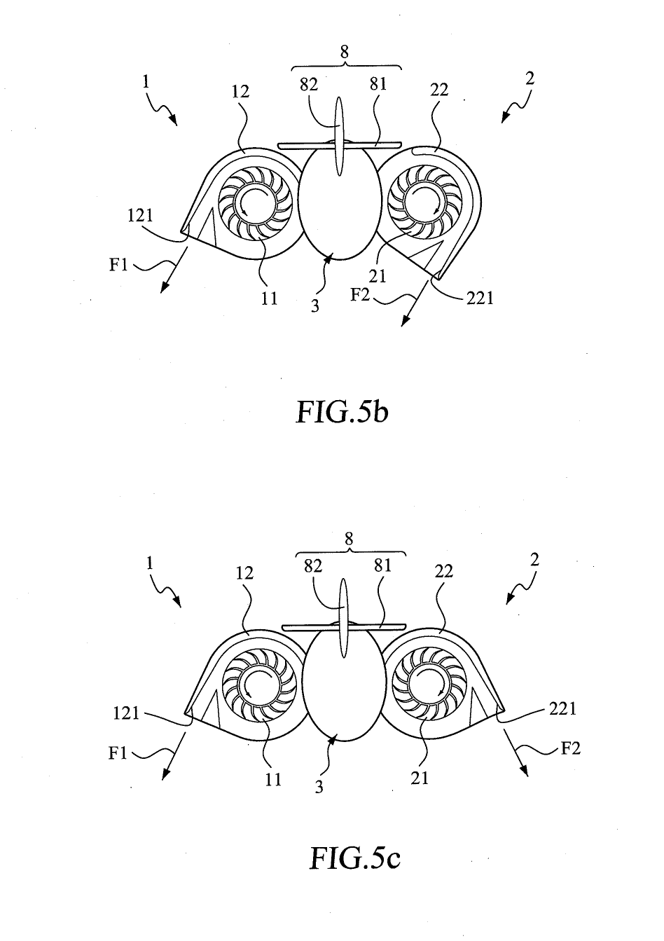

As shown in FIGS. 5a, 5b, and 5c, in some embodiments, the first guiding hood 12 of the first thrusting means 1 and the second guiding hood 22 of the second thrusting means 2 are angle adjustable. By adjusting angle of the guiding hood 12 and 22, position of air outlet 121 and 221 are changed and therefore the airflow directions of the first cross flow fan 11 and the second cross flow fan 21 are changed correspondingly. Thereby, flight altitude and direction of the cross flow fan flying device 100b can be changed.

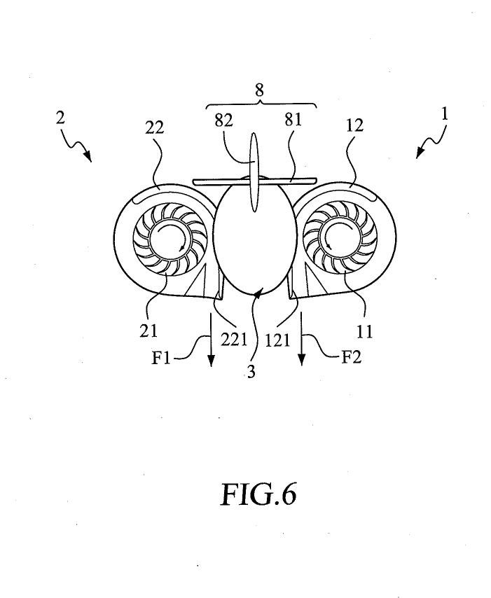

Further, rotating directions of the first cross flow fan 11 and the second cross flow fan 21 are not limited to the embodiment shown in FIG. 5a, 5b, or 5c. The first cross flow fan 11 and the second cross flow fan 21 may rotate clockwise or counter clockwise as long as they rotate in directions opposite with each other, as shown in FIG. 6.

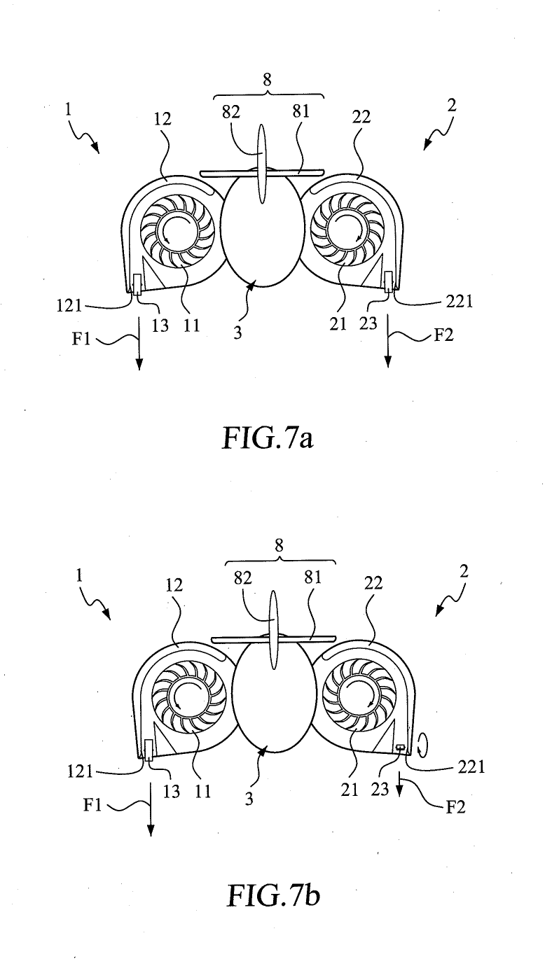

As shown in FIGS. 7a and 7b, the first thrusting means 1, similar to that of the first embodiment, may include a plurality of first airflow direction adjusting members 13 on the airflow direction of the first cross flow fan 11, and a plurality of second airflow direction adjusting members 23 on the airflow direction of the first cross flow fan 21. The airflow direction adjusting members 13 and 23 may be provided to swing between forth and back (as shown in FIGS. 7a and 7b) or to swing between right and left. By adjusting the angle of the airflow direction adjusting members 13 and 23, the output direction of airflow F1 and F2 are also changed, and therefore the cross flow fan flying device 100b is capable of flying in various directions.

Referring again to FIG. 4, the first cross flow fan 11 and the second cross flow fan 21 of this embodiment are driven by a common driving means 5 and there are several means 70, 71, and 72 connected among the driving means 5, the first cross flow fan 11, and the second cross flow fan 21. These means 70, 71, and 72 may serve as a transmitting means for transmitting driving power from the driving means 5 to the first cross flow fan 11 and the second cross flow fan 21, and one or more of them may be a differential means for allowing the first cross flow fan 11 and the second cross flow fan 21 to be driven in different speed by one driving means 5. However, arrangement of the means (driving means 5 and means 70, 71, and 72) is not limited to this. In other embodiment, the first cross flow fan 11 and the second cross flow fan 21 may be driven by individual driving means and a differential means is provided between the first cross flow fan 11 and the second cross flow fan 21.

The cross flow fan flying device 100b may further include a tail means 8 provided on a tail portion of the cross flow fan flying device 100b. The tail means 8 in this embodiment is a T-tail having a horizontal stabilizer 81 and a vertical stabilizer 82 mounted on the horizontal stabilizer 81 to improve the flying stability of the cross flow fan flying device 100b.

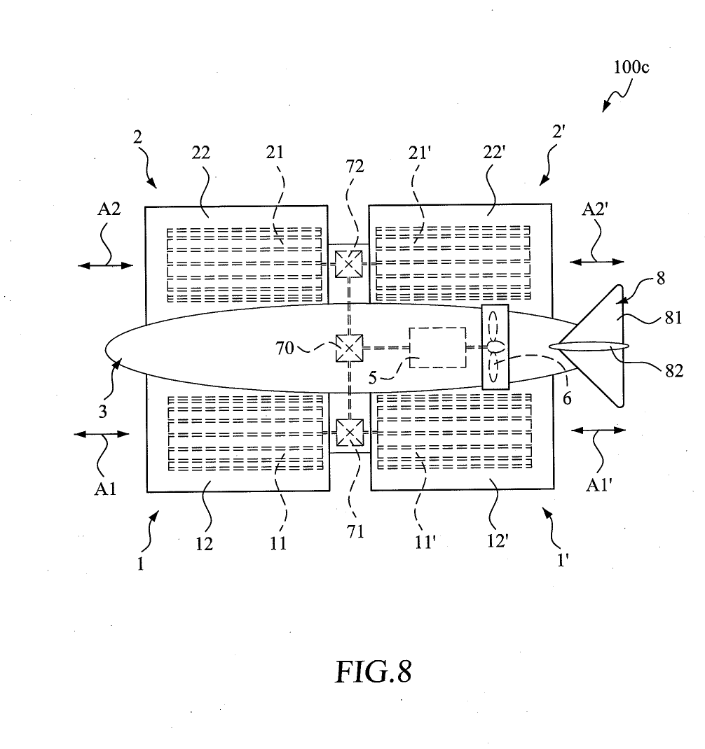

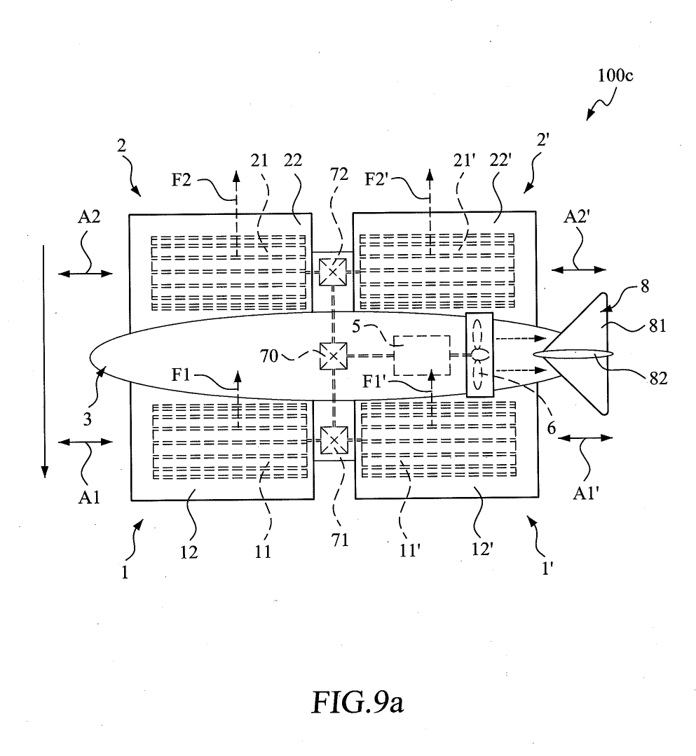

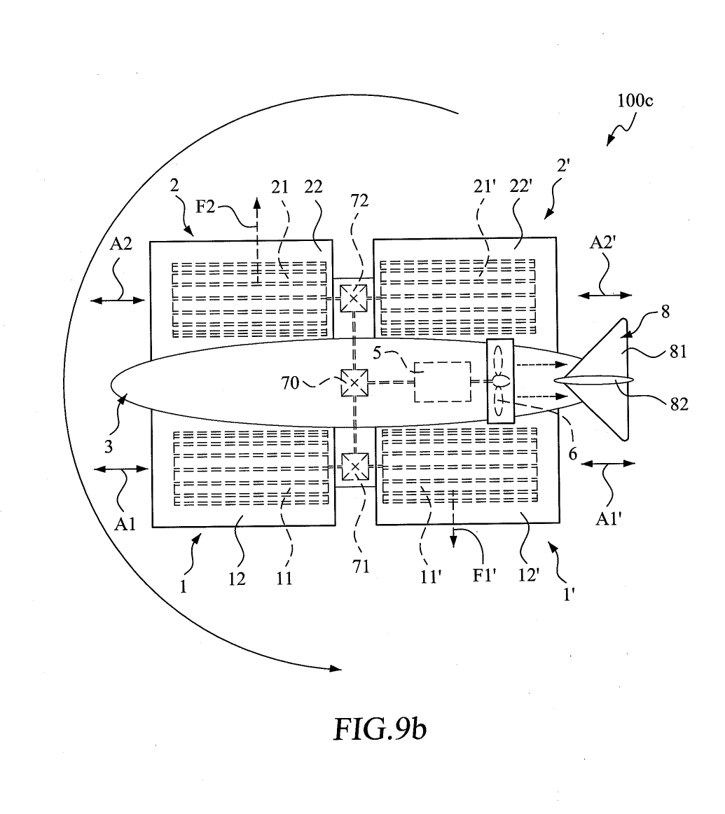

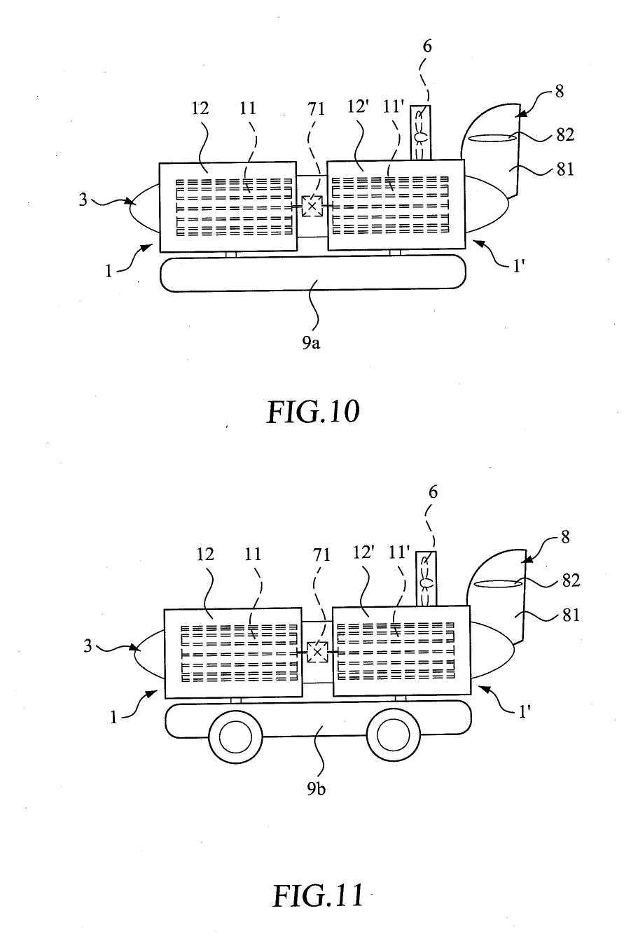

Please refer to FIGS. 8, 9a, and 9b, which are schematic drawings of various cross flow fan flying devices according to a third embodiment of the present invention. The elements of cross flow fan flying devices 100c in this embodiment are similar to those in the second embodiment. The same elements in the second embodiment are labeled with the same reference numbers as in the first embodiment. Features the same as those in the second embodiment will be omitted as appropriate.

A feature of the cross flow fan flying devices 100c in the third embodiment is that it includes four thrusting means 1, 1′, 2, and 2′. The thrusting means 1 includes a cross flow fan 11 and a guiding hood 12, the thrusting means 1′ includes a cross flow fan 11′ and a guiding hood 12′, the thrusting means 2 includes a cross flow fan 21 and a guiding hood 22, and the thrusting means 2′ includes a cross flow fan 21′ and a guiding hood 22′. The cross flow fan 11 rotates on an axis A1, the cross flow fan 21 rotates on an axis A2, the cross flow fan 11′ rotates on an axis A1′, and the cross flow fan 21′ rotates on an axis A2′. The axis A1 is parallel to the axis A2, the axis A1′ is parallel to the axis A2′, the axis A1 is coaxial to the axis A1′, and the axis A2 is coaxial to the axis A2′.

By provided many thrusting means 1, 1′, 2, and 2′, flying dexterity are flying stability of the cross flow fan flying devices 100c can be improved. In detail, because each of the thrusting means 1, 1′, 2, and 2′ can be controlled respectively to adjust degree and direction of output airflows F1, F1′, F2, and F2′, the cross flow fan flying devices 100c can perform, by adjusting airflows F1, F1′, F2, and F2′ to different degrees and directions, various flying motions such as a transverse motion (as shown in FIG. 9a) and a spinning motion (as shown in FIG. 9b) which are hard for a conventional flying device.

Further, the cross flow fan flying devices 100c may include additional parts such as a float 9a and vehicle wheels 9b for widening use of various purposes. The cross flow fan flying devices 100c having the float 9a is capable of navigating the water as well as the air. The cross flow fan flying devices 100c having the vehicle wheels 9b is capable of moving on road.

By structures described above, the cross flow fan flying device can be driven and fly by an airflow thrust generated by the first cross flow fan and the second cross flow fan, with advantage of having excellent flying dexterity and stability. The cross flow fan flying device is capable of flying with various motions as desired, such as moving toward direction, rotating or spinning toward any axis, or even staying at a fixed position. The cross flow fan flying device can adapt to any various flying environment, and thus to be used widely for multiple flying purposes.

The above description should be considered as only the discussion of the preferred embodiments of the present invention. However, a person having ordinary skill in the art may make various modifications to the present invention. Those modifications still fall within the spirit and scope defined by the appended claims.

What is claimed is:

1. A cross flow fan flying device comprising:
a first thrusting means, provided with a first cross flow fan rotating on a first axis; and
a second thrusting means, connected with the first thrusting means, provided with a second cross flow fan rotating on a second axis,
wherein the first flow fan and the second cross flow fan rotate in directions opposite with each other, and the cross flow fan flying device is driven and flies by an airflow thrust generated by the first cross flow fan and the second cross flow fan.

2. The cross flow fan flying device as claimed in claim 1, wherein the first axis is coaxial to the second axis.

3. The cross flow fan flying device as claimed in claim 1, wherein the first axis is parallel to the second axis.

4. The cross flow fan flying device as claimed in claim 1, wherein the first thrusting means is provided with a first guiding hood that covers the first cross flow fan, and the second thrusting means is provided with a second guiding hood that covers the second cross flow fan.

5. The cross flow fan flying device as claimed in claim 4, wherein the first guiding hood and the second guiding hood are angle adjustable to guide airflow directions of the first cross flow fan and the second cross flow fan respectively.

6. The cross flow fan flying device as claimed in claim 1, wherein the first thrusting means is provided with a first airflow direction adjusting member in an airflow direction of the first cross flow fan, and the second thrusting means is provided with a second airflow direction adjusting member in an airflow direction of the first cross flow fan.

7. The cross flow fan flying device as claimed in claim 1, further comprising a tail means provided on a tail portion of the cross flow fan flying device.

8. The cross flow fan flying device as claimed in claim 1, further comprising a propeller for propelling the cross flow fan flying device.

9. The cross flow fan flying device as claimed in claim 1, further comprising a multiway transmitting means connected among a driving means, the first cross flow fan and the second cross flow fan in such a manner to allow the driving means to drive the first cross flow fan and the second cross flow in directions opposite with each other.

10. The cross flow fan flying device as claimed in claim 1, further comprising a differential means connected between the first cross flow fan and the second cross flow fan.
